(19) United States
(12) Patent Application Publication
(10) Pub. No.: US 2017/0102048 A1
(43) Pub. Date: Apr. 13, 2017

(54) HIGH PERFORMANCE FLEXPLATE WITH ALTERNATING RADIAL WALL THICKNESS AND MULTI-PROFILE LIGHTENING HOLES

(71) Applicant: Ford Global Technologies, LLC, Dearborn, MI (US)

(72) Inventors: Christopher Joseph GUARRACINO, Northville, MI (US); David Allen JANSON, Plymouth, MI (US); Laurence Andrew DEUTSCH, Farmington Hills, MI (US)

(21) Appl. No.: 14/881,189

(22) Filed: Oct. 13, 2015

(51) Int. Cl. F16F 15/30

(52) U.S. Cl. CPC F16F 15/30

(57) ABSTRACT

A flexplate includes a generally disk-shaped body. The body has a hub portion, a peripheral portion, an intermediate portion between the hub portion and the peripheral portion, and a thickness dimension orthogonal to a radius of the body. A thickness of the hub portion differs from a thickness of the intermediate portion, and the thickness of the intermediate portion differs from a thickness of the peripheral portion.

### TECHNICAL FIELD

This disclosure relates to a flexplate for a transmission system in an automobile.

### BACKGROUND

In automotive or other applications utilizing an automatic transmission, a flexplate is generally provided between a drive source and a torque converter. A flexplate is a disk that connects the output from a drive source, e.g. an engine crankshaft, to the input of the torque converter. In hybrid-electric vehicle (HEV) or plug-in hybrid-electric vehicle (PHEV) applications, the flexplate may be provided between a motor-generator output and the crankshaft. In some applications, teeth may be provided along the periphery of the flexplate to cooperate with a starter motor and facilitate starting the engine.

### SUMMARY

A flexplate according to the present disclosure includes a generally disk-shaped body. The body has a hub portion, a peripheral portion, an intermediate portion between the hub portion and the peripheral portion, and a thickness dimension orthogonal to a radius of the body. A thickness of the hub portion differs from a thickness of the intermediate portion, and the thickness of the intermediate portion differs from a thickness of the peripheral portion.

According to a first embodiment, the thickness of the intermediate portion is less than the thickness of the hub portion and less than the thickness of the peripheral portion.

According to a second embodiment, the intermediate portion has a first region proximate the hub portion, a second region radially outward from the first region, and a third region radially outward the second region and proximate the peripheral portion. In such an embodiment, the first region has a first region thickness, the second region has a second region thickness, and the third region has a third region thickness, the second region thickness being different from the first region thickness and different from the third region thickness.

According to a third embodiment, the disk-shaped body has a first face and a second face. A hole is provided in the intermediate portion. The hole extends from the first face through the second face. The hole has a periphery with a concave profile. In some such embodiments, the hole is arranged at first circumferential location, a second hole is provided in the intermediate portion at a second circumferential location. The second hole extends from the first face through the second face. The second hole has a periphery with a concave profile.

According to a fourth embodiment, the disk-shaped body has a first face and a second face. At least one hole is provided in the intermediate portion. A welding flange extends from the peripheral portion into a respective hole of the at least one hole. In some such embodiments, the at least one hole includes at least two holes arranged circumferentially about the intermediate portion. Each respective hole of the at least two holes has an associated welding flange extending from the peripheral portion into the respective hole.

A method of manufacturing a flexplate for an automotive drive system according to the present disclosure includes providing a disk-shaped body. The body has a first face, a second face, a hub portion, a peripheral portion, and an intermediate portion between the hub portion and peripheral portion. A thickness of the hub portion differs from a thickness of the intermediate portion and the thickness of the intermediate portion differs from a thickness of the peripheral portion. The method additionally includes providing a hole through the body. The hole extends from the first face through the second face. The hole has a periphery with a concave profile.

According to a first embodiment of the method, the thickness of the intermediate portion is less than the thickness of the hub portion. In a variation of the first embodiment, the thickness of the intermediate portion is less than the thickness of the peripheral portion.

According to a second embodiment of the method, the intermediate portion has a first region proximate the hub portion, a second region radially outward from the first region, and a third region radially outward the second region and proximate the peripheral portion. In such an embodiment, the first region has a first region thickness, the second region has a second region thickness, and the third region has a third region thickness. The second region thickness is different from the first region thickness and different from the third region thickness.

According to a third embodiment, the method further includes providing a second hole through the body. The second hole extends from the first face through the second face and is spaced circumferentially from the hole. The second hole has a periphery with a concave profile.

An automotive vehicle according to the present disclosure includes a drive source, a drive shaft configured to transmit power from the drive source, a torque converter having an input, and a flexplate drivingly coupling the drive shaft to the torque converter input. The flexplate has a generally disk-shaped body with a hub portion, a peripheral portion, an intermediate portion between the hub portion and the peripheral portion, and a thickness dimension orthogonal to a radius of the body. A thickness of the hub portion differs from a thickness of the intermediate portion, and the thickness of the intermediate portion differs from a thickness of the peripheral portion.

According to a first embodiment, the drive source includes an internal combustion engine.

According to a second embodiment, the drive source includes an electric machine.

According to a third embodiment, the thickness of the intermediate portion is less than the thickness of the hub portion and less than the thickness of the peripheral portion

According to a third embodiment, the disk-shaped body has a first face and a second face. A hole is provided in the intermediate portion. The hole extends from the first face through the second face. The hole has a periphery with a concave profile. In some such embodiments, the hole is arranged at first circumferential location, a second hole is provided in the intermediate portion at a second circumferential location. The second hole extends from the first face through the second face. The second hole has a periphery with a concave profile.

According to a fourth embodiment, the disk-shaped body has a first face and a second face. At least one hole is provided in the intermediate portion. A welding flange extends from the peripheral portion into a respective hole of the at least one hole. In some such embodiments, the at least one hole includes at least two holes arranged circumferentially about the intermediate portion. Each respective hole of the at least two holes has an associated welding flange extending from the peripheral portion into the respective hole.

Embodiments according to the present disclosure provide a number of advantages. For example, the present disclosure provides a flexplate with reduced weight and increased torsional strength relative to known designs. The reduction in weight may lead to reduced material costs, improved fuel economy, and improved customer satisfaction. Furthermore, these advantages may be achieved without significantly altering the manufacturing process relative to the manufacturing processes for known flexplates.

The above and other advantages and features of the present disclosure will be apparent from the following detailed description of the preferred embodiments when taken in connection with the accompanying drawings.

### BRIEF DESCRIPTION OF THE DRAWINGS

FIG. 1 illustrates a schematic representation of an automotive vehicle;

FIG. 2A illustrates a first view of a prior art flexplate;

FIG. 2B illustrates a second view of a prior art flexplate;

FIG. 3A illustrates a first view of a flexplate according to the present disclosure;

FIG. 3B illustrates a second view of a flexplate according to the present disclosure;

FIG. 3C illustrates a third view of a flexplate according to the present disclosure; and

FIG. 4 is a flow chart illustrating a method of manufacturing a flexplate according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In automotive and other applications making use of an internal combustion engine with an automatic transmission, a flexplate is typically provided to connect the engine's crankshaft to the torque converter of the transmission. Similarly, in HEV or PHEV applications, a flexplate may be provided between an electric machine, functioning as a traction motor-generator, and a torque converter. The flexplate transfers drive torque from the drive source (e.g. internal combustion engine or motor-generator) to the torque converter. The flexplate is configured to flex across its main axis to take up motion in the torque converter as rotational speeds change.

The flexplate is generally disk-shaped and made of metal, such as steel, titanium, or aluminum. In some configurations, the flexplate is provided with teeth about the periphery of the disk. The teeth are configured to engage with and be driven by a starter motor in order to start the engine.

Typically, flexplates for high demand applications such as racing, with high torque & thrust loads, are machined. Flexplates for low demand applications, such as family vehicles, are generally stamped.

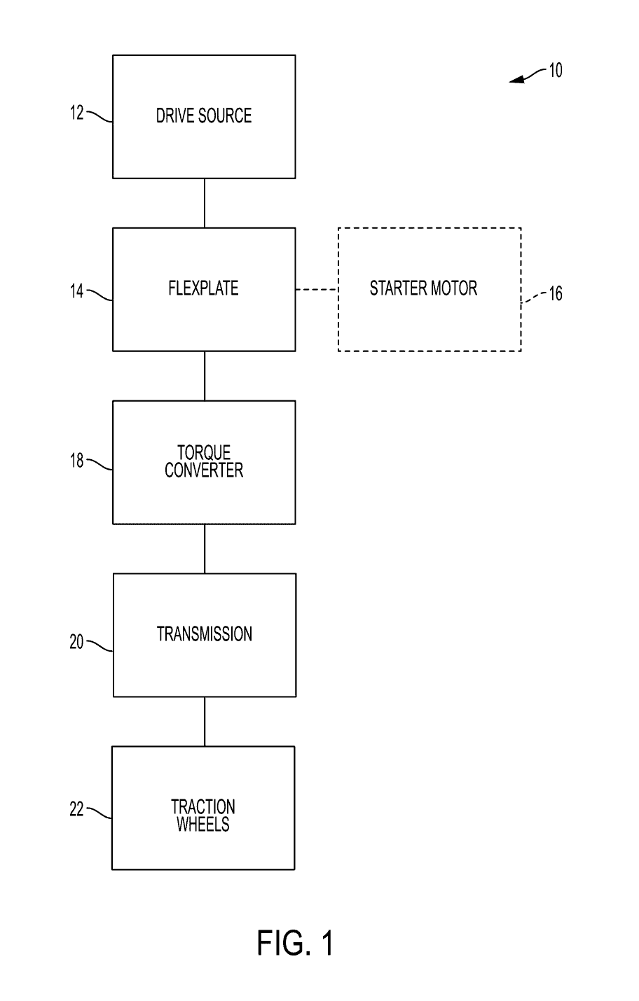

Referring now to FIG. 1, an automotive vehicle 10 is shown in schematic form. The vehicle 10 includes a drive source 12. The drive source 12 may include an internal combustion engine. In other embodiments, the drive source 12 may include an electric machine. The drive source 12 is drivingly coupled to a flexplate 14, e.g. via a drive shaft. In embodiments where the drive source 12 includes an internal combustion engine, the flexplate 14 is optionally coupled to a starter motor 16. In such embodiments, the starter motor 16 is configured to impart rotational motion to the flexplate 14 to facilitate starting the internal combustion engine. The flexplate 14 is drivingly coupled to an input of a torque converter 18. The output of the torque converter 18 is drivingly coupled to a transmission 20. The transmission 20 is drivingly coupled to traction wheels 22 according to various fixed and/or variable gear ratios.

In the following discussion of the Figures, a polar coordinate system is utilized. A radial direction extends from the hub toward the periphery. A circumferential direction extends tangentially to the radial direction within the general plane of the flexplate. An axial direction extends orthogonal to the radial direction.

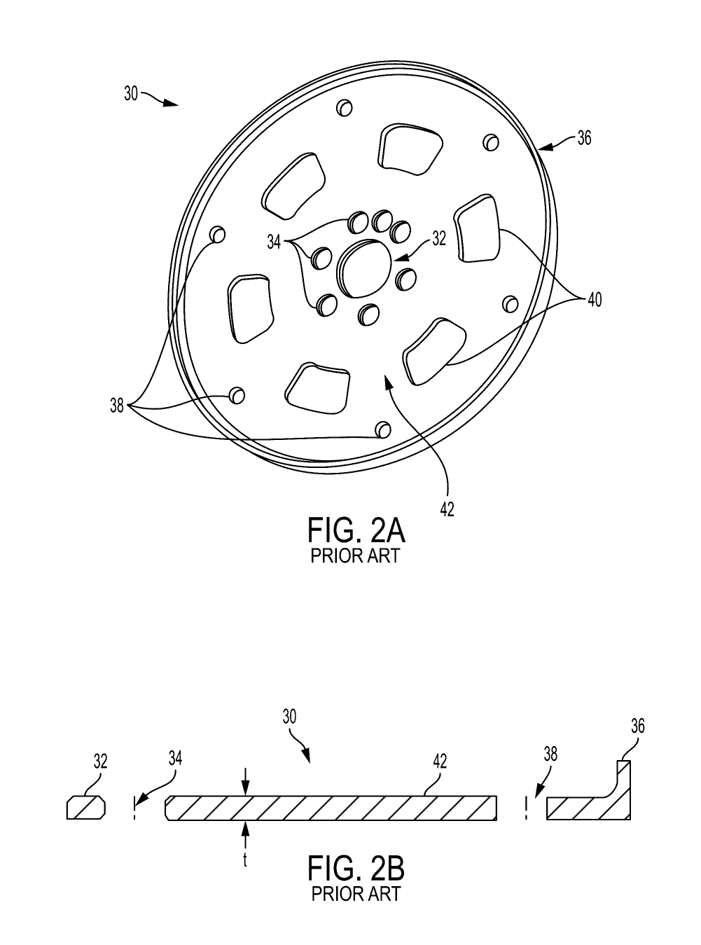

Referring now to FIG. 2A, a representative prior art flexplate 30 is illustrated in an isometric view. As may be seen, the flexplate 30 is generally disc-shaped. The flexplate 30 includes a hub portion 32 with an opening configured to fit about a crankshaft. The flexplate 30 also includes a plurality of crankshaft bolt holes 34 arranged about the hub portion. The crankshaft bolt holes 34 are configured to receive fasteners to couple the flexplate 30 to a crankshaft coupling plate. The flexplate 30 also includes a peripheral portion 36. A ring gear may be provided around the peripheral portion 36 to engage with a starter motor. A plurality of torque converter bolt holes 38 are arranged circumferentially about the flexplate near the peripheral portion 36. The torque converter bolt holes 38 are configured to receive fasteners to couple the flexplate 30 to a torque converter coupling plate. In addition, a plurality of cutouts 40 are provided in an intermediate region 42, arranged at a radial position between the hub opening 32 and the peripheral portion 36. The cutouts 40 are configured to reduce the overall weight of the flexplate 30 without adversely impacting the stress characteristics of the flexplate 30. The cutouts 40 have a regular shape, e.g. rectangular or circular, in a repeated pattern about the circumference of the flexplate 30.

Referring now to FIG. 2B, showing the prior art flexplate 30 in radial cross-section, the prior art flexplate 30 has a generally constant thickness t from the hub portion 32 through the intermediate portion 42. The thickness t is measured along the axial direction. During operation, the flexplate 30 transfers torque from a crank shaft to a torque converter. The thickness t is selected to accommodate the stresses generated in the flexplate during operation, and also to maintain sufficient flexibility to accommodate motion in the torque converter during a speed change. The thickness t may be, for example, approximately 5 mm. The peripheral portion 36 has an increased thickness relative to the rest of the flexplate 30 to accommodate the ring gear.

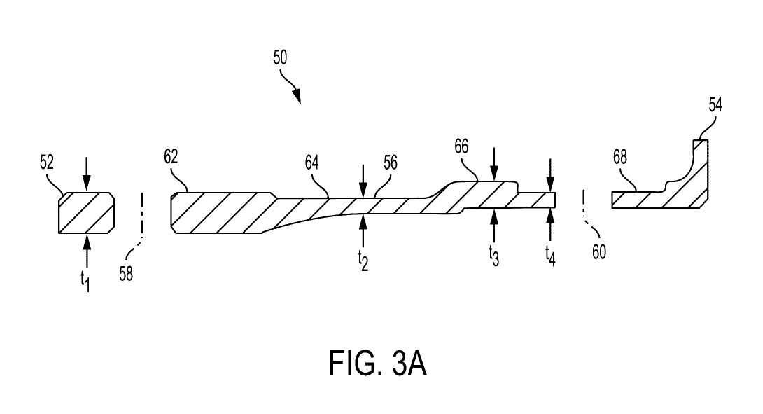

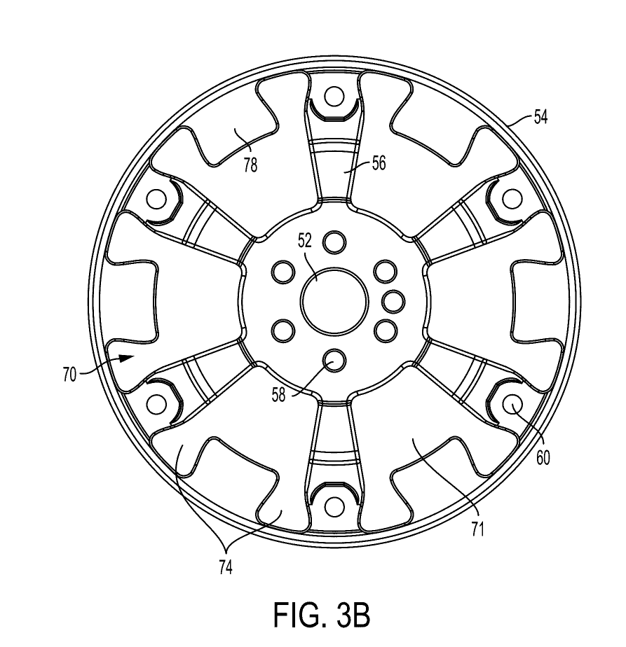

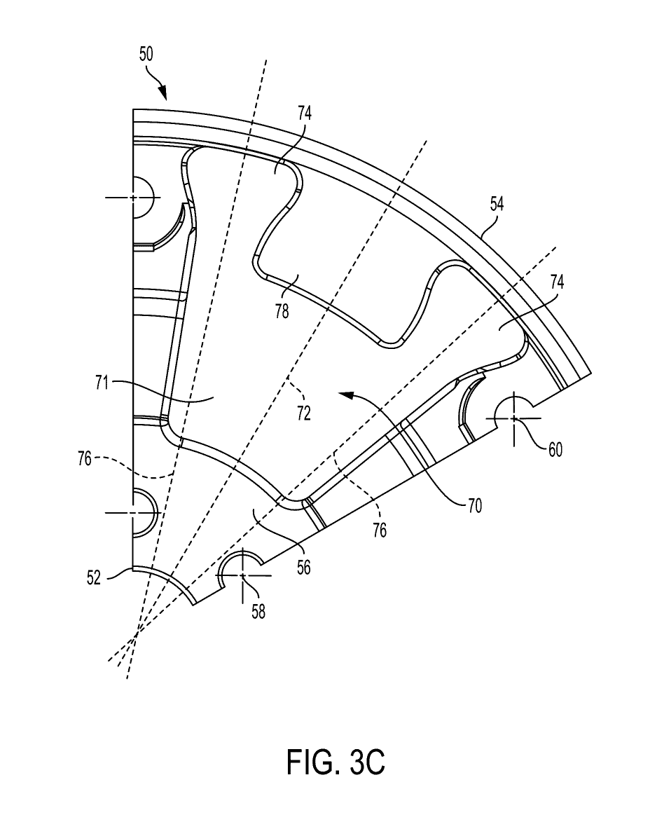

Referring now to FIG. 3A, a flexplate 50 according to the present disclosure is shown in radial cross-section. The flexplate 50 is preferably made of metal, such as aluminum or steel. The flexplate 50 includes a hub portion 52, a peripheral portion 54, and an intermediate portion 56 between the hub portion 52 and peripheral portion 54. Crankshaft bolt holes 58 are provided about the hub portion 52, and torque converter bolt holes 60 are provided about the peripheral portion 54.

As with known flexplates, the hub portion 52 has a thickness t₁, and the peripheral portion 54 has an increased thickness to accommodate a ring gear. The thickness dimension is measured in an axial direction. In a preferred embodiment, the thickness t₁ is consistent with those of prior art flexplates, e.g. approximately 5 mm. Other thicknesses may, of course, be used.

However, unlike known configurations, the thickness between the hub portion 52 and the peripheral portion 54 is not constant. The intermediate portion 56 includes, in order from hub to periphery, a first region 62, a second region 64, a third region 66, and a fourth region 68. The first region 62 has a thickness t₁ consistent with that of the hub portion 52. The second region 64 has a thickness t₂. The thickness t₂ is less than the thickness t₁. The thickness t₂ may be, for example, 3 mm. The third region 66 has a thickness t₃. The thickness t₃ is greater than the thickness t₂. The thickness t₃ may be equal to or different from the thickness t₁. The fourth region 68 has a thickness t₄. The thickness t₄ is less than the thickness t₃. The thickness t₄ may be equal to or different from the thickness t₂.

As may be seen, this configuration provides a thinner cross-section in some regions of the intermediate portion 56 relative to known flexplates. Surprisingly, analysis shows that such a design, i.e. reducing the thickness of the intermediate portion 56, decreases the stresses present in the intermediate portion 56 during operation relative to those present in corresponding locations of a conventional flexplate design.

Referring now to FIGS. 3B and 3C, a front view and a front detail view, respectively, of a flexplate 50 according to the present disclosure are shown. Because the reduced thickness in the intermediate portion 56 provides a decrease in the stresses present during operation, larger and more complicated cutout portions may be provided through the flexplate 50. In this embodiment, a plurality of cutouts 70 are provided, arranged circumferentially about the flexplate 50. Each cutout 70 includes a first portion 71, provided at a first radial position and centered about a first angular position 72. In this embodiment, the first portion 71 of the cutout pattern 70 is generally rectangular. In addition, each cutout 70 includes a second portion 74, provided at a second radial position and centered about a second angular position 76. The number of second portions 74 of each cutout 70 may be different from the number of first portions 71 of the cutout 70, and the second angular position 76 may be different from the first angular position 72. In this embodiment, the second portion 74 is provided radially outboard of the first portion 71. Furthermore, in this embodiment, each cutout 70 includes two second portions 74 contiguous with each first portion 71. The cutouts 70, including first portions 71 and second portions 74 as shown in FIG. 3B, may maintain adequate torsional stiffness in the flexplate 50, while simultaneously increasing axial compliance of the flexplate 50 and reducing weight of the flexplate 50.

In a preferred embodiment, weld flanges 78 are provided proximate the peripheral portion 54. The weld flanges 78 are arranged between the torque converter bolt holes 60 and protrude into the cutout 70. As a result, the shape of the cutout 70 may be described as concave or re-entrant, i.e. the profile of the perimeter of the cutout 70 includes a portion that protrudes inward. The weld flanges 78 provide weld points to facilitate attachment of the flexplate 50 to a timing plate via welding.

As may be seen, the addition of a second cutout pattern may result in a larger amount of material being removed from the face of the flexplate 50 relative to the known configuration shown in FIG. 2. By combining the increased cutout areas with the reduction in thickness shown in FIG. 3A, embodiments according to the present disclosure may be up to 30% lighter than known flexplates. The reduction in weight may be reflected in a decrease in fuel consumption in the assembled vehicle. In addition, the reduction in weight may result in a corresponding reduction in material costs.

Variations of the above design are, of course, possible. Other considered embodiments may include other patterns of thicknesses in the profile sections. For example, one alternative embodiment may include a generally constant thickness through the intermediate portion, with the intermediate portion thickness being less than the hub portion thickness or the peripheral portion thickness. Other considered embodiments may also include other combinations of cutout patterns.

As an additional advantage, embodiments according to the present disclosure may be made using machining methods that are not significantly different from those for known high-performance flexplates.

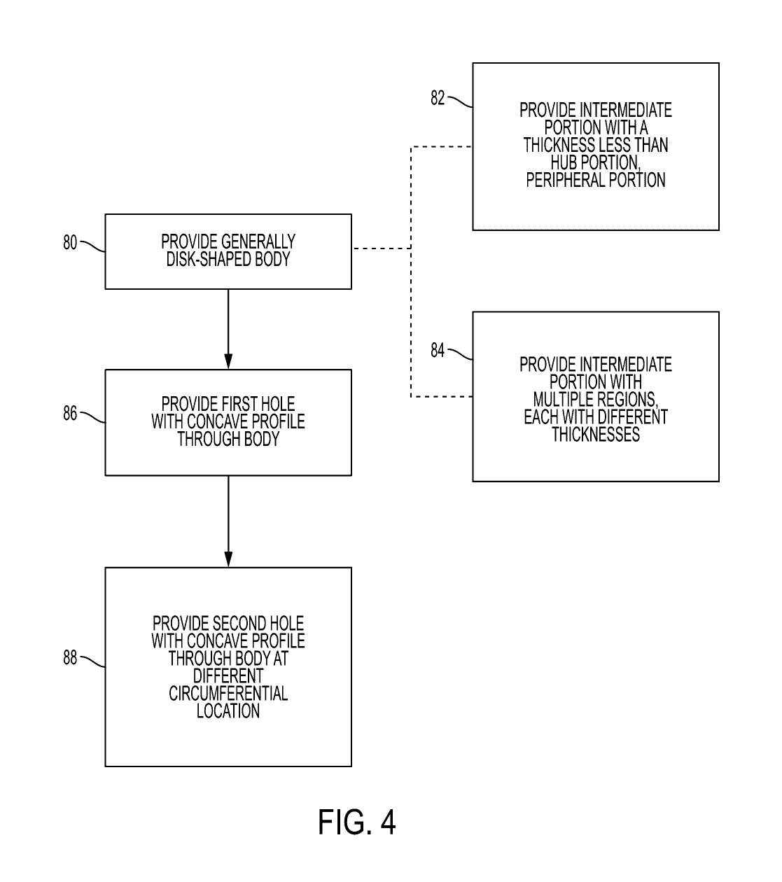

Referring now to FIG. 4, a method of manufacturing a flexplate according to the present disclosure is shown in flowchart form. A generally disk-shaped body is provided, as illustrated at block 80. This may include, for example, machining a metal such as aluminum or steel into the appropriate shape. This may include providing an intermediate portion of the body with a thickness that is less than a hub portion thickness or a peripheral portion thickness, as illustrated at block 82. This may additionally, or alternatively, include providing the intermediate portion of the body with multiple regions, each region having a different thickness, as illustrated at block 84. For example, a first region proximate the hub portion may have a first thickness, a second region radially outward of the first region may have a second thickness, and a third region radially outward of the second region and proximate the peripheral portion may have a third thickness. According to this example, the second thickness is different from the first thickness and different from the third thickness.

The method additionally includes providing a first hole through the body, as illustrated at block 86. The first hole has a periphery with a concave profile.

The method further includes providing a second hole through the body, as illustrated at block 88. The second hole has a periphery with a concave profile. The second hole is provided at a different circumferential location from the first hole. Additional holes may also be provided.

As may be seen, the present disclosure provides a flexplate with reduced weight and increased torsional strength relative to known designs. The reduction in weight may lead to reduced material costs, improved fuel economy, and improved customer satisfaction. Furthermore, these advantages may be achieved without significantly altering the manufacturing process relative to the manufacturing processes for known flexplates.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A flexplate for coupling a drive source to a torque converter, comprising:
a generally disk-shaped body having a hub portion, a peripheral portion, an intermediate portion between the hub portion and the peripheral portion, wherein a thickness of the hub portion differs from a thickness of the intermediate portion and the thickness of the intermediate portion differs from a thickness of the peripheral portion.

2. The flexplate of claim 1, wherein the thickness of the intermediate portion is less than the thickness of the hub portion and less than the thickness of the peripheral portion

3. The flexplate of claim 1, wherein the disk-shaped body has a first face and a second face, and wherein a hole is provided in the intermediate portion, the hole extending from the first face through the second face, the hole having a periphery with a concave profile.

4. The flexplate of claim 3, wherein the hole is arranged at a first circumferential location, and wherein a second hole is provided in the intermediate portion, the second hole extending from the first face through the second face, the second hole having a periphery with a concave profile, the second hole being arranged at a second circumferential location.

5. The flexplate of claim 1, wherein the disk-shaped body has a first face and a second face, wherein at least one hole is provided in the intermediate portion, and wherein a welding flange extends from the peripheral portion into a respective hole of the at least one hole.

6. The flexplate of claim 5, wherein the at least one hole includes at least two holes arranged circumferentially about the intermediate portion, each respective hole of the at least two holes having an associated welding flange extending from the peripheral portion into the respective hole.

7. The flexplate of claim 1, wherein the intermediate portion has a first region proximate the hub portion, a second region radially outward from the first region, and a third region radially outward the second region and proximate the peripheral portion, and wherein the first region has a first region thickness, the second region has a second region thickness, and the third region has a third region thickness, the second region thickness being different from the first region thickness and different from the third region thickness.

8. A method of manufacturing a flexplate for an automotive drive system, comprising:
providing a disk-shaped body having a first face, a second face, a hub portion, a peripheral portion, and an intermediate portion between the hub portion and peripheral portion, wherein a thickness of the hub portion differs from a thickness of the intermediate portion and the thickness of the intermediate portion differs from a thickness of the peripheral portion; and
providing a hole through the body, the hole extending from the first face through the second face, the hole having a periphery with a concave profile.

9. The method of claim 8, wherein the thickness of the intermediate portion is less than the thickness of the hub portion.

10. The method of claim 9, wherein the thickness of the intermediate portion is less than the thickness of the peripheral portion.

11. The method of claim 8, wherein the intermediate portion has a first region proximate the hub portion, a second region radially outward from the first region, and a third region radially outward the second region and proximate the peripheral portion, and wherein the providing the disk shaped body comprises providing the first region with a first region thickness, the second region with a second region thickness, and the third region with a third region thickness, the second region thickness being different from the first region thickness and different from the third region thickness.

12. The method of claim 8, further comprising providing a second hole through the body, the second hole extending from the first face through the second face and being spaced circumferentially from the hole, the second hole having a periphery with a concave profile.

13. An automotive vehicle comprising:
a drive source;
a drive shaft configured to transmit power from the drive source;
a torque converter having an input; and
a flexplate drivingly coupling the drive shaft to the torque converter input, the flexplate having a generally disk-shaped body with a hub portion, a peripheral portion, an intermediate portion between the hub portion and the peripheral portion, wherein a thickness of the hub portion differs from a thickness of the intermediate portion and the thickness of the intermediate portion differs from a thickness of the peripheral portion.

14. The automotive vehicle of claim 13, wherein the thickness of the intermediate portion is less than the thickness of the hub portion and less than the thickness of the peripheral portion

15. The automotive vehicle of claim 13, wherein the disk-shaped body has a first face and a second face, and wherein a hole is provided in the intermediate portion, the hole extending from the first face through the second face, the hole having a periphery with a concave profile.

16. The automotive vehicle of claim 15, wherein the hole is arranged at first circumferential location, and wherein a second hole is provided in the intermediate portion, the second hole extending from the first face through the second face, the second hole having a periphery with a concave profile, the second hole being arranged at a second circumferential location.

17. The automotive vehicle of claim 13, wherein the disk-shaped body has a first face and a second face, wherein at least one hole is provided in the intermediate portion, and wherein a welding flange extends from the peripheral portion into a respective hole of the at least one hole.

18. The automotive vehicle of claim 17, wherein the at least one hole includes at least two holes arranged circumferentially about the intermediate portion, each respective hole of the at least two holes having an associated welding flange extending from the peripheral portion into the respective hole.

19. The automotive vehicle of claim 13, wherein the drive source includes an internal combustion engine.

20. The automotive vehicle of claim 13, wherein the drive source includes an electric machine.
